(19) United States
(12) Patent Application Publication
(10) Pub. No.: US 2002/0071707 A1
(43) Pub. Date: Jun. 13, 2002

(54) Dual ended lip cosmetic applicator

(76) Inventors: Diane C. Breidenbach, Smithtown, NY (US); Laurence W. Mille, Smithtown, NY (US)

Correspondence Address: Thomas A. O'Rourke, Wyatt, Gerber & O'Rourke, 99 Park Avenue, New YORK, NY, 10016, US

(21) Appl. No.: 09/842,372

(22) Filed: Apr. 25, 2001

Related U.S. Application Data
(63) Continuation-in-part of application No. 09/515,956, filed on Feb. 29, 2000.

(51) Int. Cl. B05C 17/01; B67D 5/00

(52) U.S. Cl. 401/171; 401/183

(57) ABSTRACT

A dual cosmetic container is disclosed. The container has a sleeve that has a first end and a second end, each of the ends are adapted to receive a receptacle for containing a cosmetic product. The cosmetic product in the first receptacle is different from the cosmetic product in the second receptacle. At least one of the products in one of the receptacles is a lip product.

The present application is a continuation-in-part of U.S. application Ser. No. 09/515,956, filed on Feb. 29, 2001 the disclosures of which are incorporated herein by reference. The present application is related to U.S. patent application Ser. No.______ filed concurrently herewith, the disclosures of which are incorporated herein by reference.

### FIELD OF THE INVENTION

This invention relates to the field of cosmetic packaging, in particular cosmetic packaging that is attractive and at the same time provides multiple cosmetic products in a form that conserves space particularly in a women's purse, pocket book or other carrying device.

### BACKGROUND OF THE INVENTION

Cosmetics is a major industry today with a myriad of different products. Many consumers use a variety of such products as lip treatments, facial powders and creams, eye shadow, eye liner, nail polish etc. Moreover, users of cosmetics frequently have an active lifestyle and partake of many activities during the day. Unfortunately, many cosmetic products can become smudged, worn away etc., over time during the day. As a result, there is a desire by many users to carry many of these products along with them during the day and re-apply them as needed. Many users carry these items in a purse, pocket book, back pack, satchel or other carrying device.

Although carrying devices such as purses come in a variety of sizes they all share one common feature. Frequently, no matter how large the purse or pocket book, it is never quite large enough or light enough for the active consumer. There always seems to be a need to add more items to the purse. Yet users are constrained by size and space limitations. Frequently, there is insufficient room for each of the items desired to be included by the consumer. Similarly, many of the cosmetic products come in large sizes that take up considerable volume in the carrying case.

One approach to solving the space issue is to provide smaller products i.e, travel or purse size cosmetic products such as mascara, perfume, powder, lip treatments, etc. that are small in size thus increasing the number of items that can be stored in a purse. While these petite items enhance the portability aspect of the product being packaged, there is a downside in that the quantity of product present in the package is reduced thus reducing the value to the consumer. Another problem with the smaller sized packages is the difficulty that the user has in finding the desired product in a reasonable period of time. In a large purse or pocketbook where there are a number of items both cosmetic and non cosmetic stored, the smaller size of the travel versions of the product have a tendency to become buried in the bottom of the purse thus rendering it difficult to locate the item.

Accordingly, there is a need for an improved cosmetic package for cosmetics that is capable of being stored in a purse handbag or other accouterment in as little space as possible.

### OBJECTS OF THE INVENTION

It is an object of the present invention to provide a cosmetic container that occupies less space in a purse or bag.

It is an object of the present invention to provide a combination package for carrying two or more cosmetic products preferably different cosmetics products in a single package.

It is an object of the present invention to provide a lip product and an perfume product in a single package.

It is an object of the present invention to provide a lip product and an eye product in a single package.

It is an object of the present invention to provide a lip product and a facial product in a single package.

It is an object of the present invention to provide a lip product and a nail product in a single package.

It is an object of the present invention to provide a lip product and a cosmetic serum in a single package.

### SUMMARY OF THE INVENTION

The present invention is for an improved cosmetic package that provides the user with two cosmetic materials in a single dual ended container. The present invention provides a lip product in at least one end of the container. The container typically has a pair of receptacles that are connected together by means of a center sleeve that is typically round in cross-section, although any cross-sectional shape is possible. The sleeve is preferably open at each end and generally hollow in the center. The sleeve is provided with a means for connecting a receptacle to the sleeve such as for example a threaded connection. In one embodiment, the cap of the lip product is present in the sleeve and the lip product is a separate member that is inserted into the cap. In an alternative embodiment, the lip product applicator is present in the sleeve and the portion of the applicator that is used to apply the product to a user's lips extends from the sleeve. In this embodiment, the cap for the lip product is a separate member from the sleeve.

The lip product is preferably applied by an applicator that is tapered in the form of a traditional stick of lipstick and the product may be dispensed by a driving means that forces the lip product from the dispenser. In a preferred embodiment the driving means for the lip applicator has a surface configuration that mates with the interior surface of the applicator tip so that any voids between the applicator interior and the driving means are minimized to permit removal of greater amounts of product.

The second end of the dual ended applicator may contain virtually any type of product and can include a lip product, a nail product, a facial product, an eye product, a cosmetic serum, a perfume, etc.

### BRIEF DESCRIPTION OF THE DRAWINGS

FIG. 1 shows a side view of the container of the present invention for a lip product and a fragrance containing product that may be applied by a rollerball applicator in a single package.

FIG. 1A is a side view of the sleeve of the container of FIG. 1

FIG. 1B is a view of the circular cross section of the sleeve of FIG. 1A taken along A-A.

FIG. 1C is a side view of the cap for the sleeve of Figure 1A.

FIG. 1D is an alternative embodiment of the cap of FIG. 1C

FIG. 2 shows the container of FIG. 1 with the components separated.

FIG. 3 shows a side view of the container of the present invention for a lip product and a facial product in a single package where the facial product may also be applied by a rollerball applicator.

FIG. 4 shows the container of FIG. 3 with the components separated.

FIG. 5 shows a side view of the container of the present invention for a lip product and a nail product in a single package where the nail product may be applied by a brush.

FIG. 6 shows the container of FIG. 5 with the components separated.

FIG. 7 shows a side view of the container of the present invention for a pair of lip products in a single package.

FIG. 8 shows the container of FIG. 7 with the components separated.

FIG. 9 shows an alternate arrangement for the container of FIGS. 1 and 3.

FIG. 10 shows one embodiment of the mechanism for the lip applicator of the present invention with a perfume or facial product in a single package.

FIG. 11 shows a side view of the container of the present invention for a lip product and a second product in a single package where the second product may be applied by a mascara type brush.

FIG. 12 shows the container of FIG. 11 with the components separated.

FIG. 13 shows a side view of the container of the present invention for a lip product and a second product in a single package where the second product may be applied by a doe foot applicator.

FIG. 14 shows the container of FIG. 13 with the components separated.

### DETAILED DESCRIPTION OF THE INVENTION

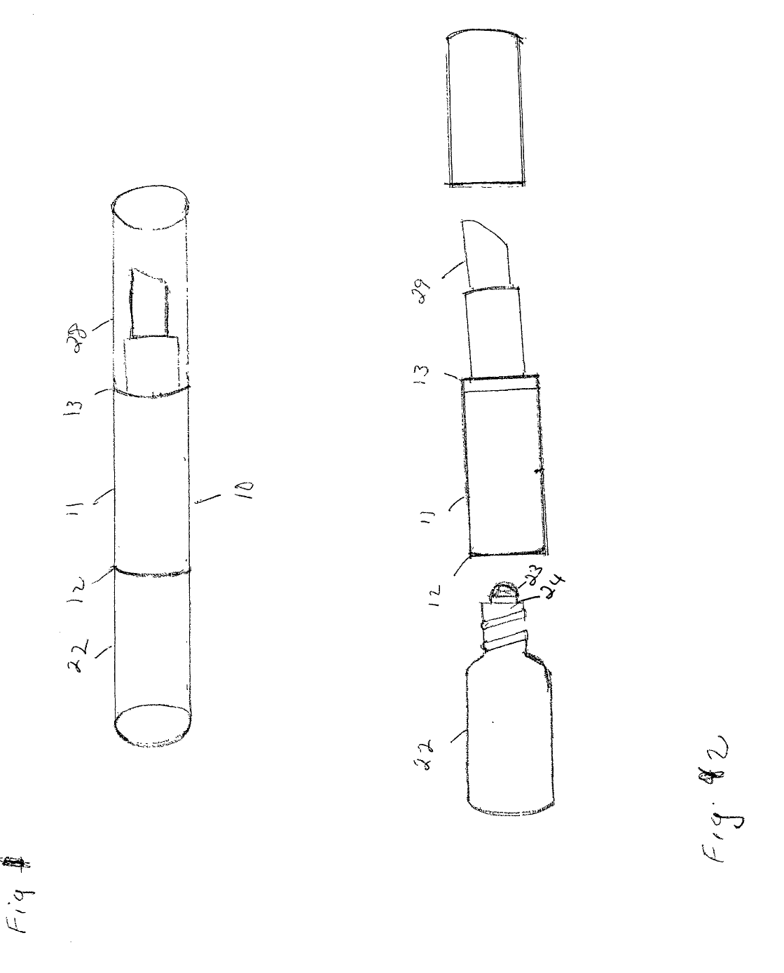

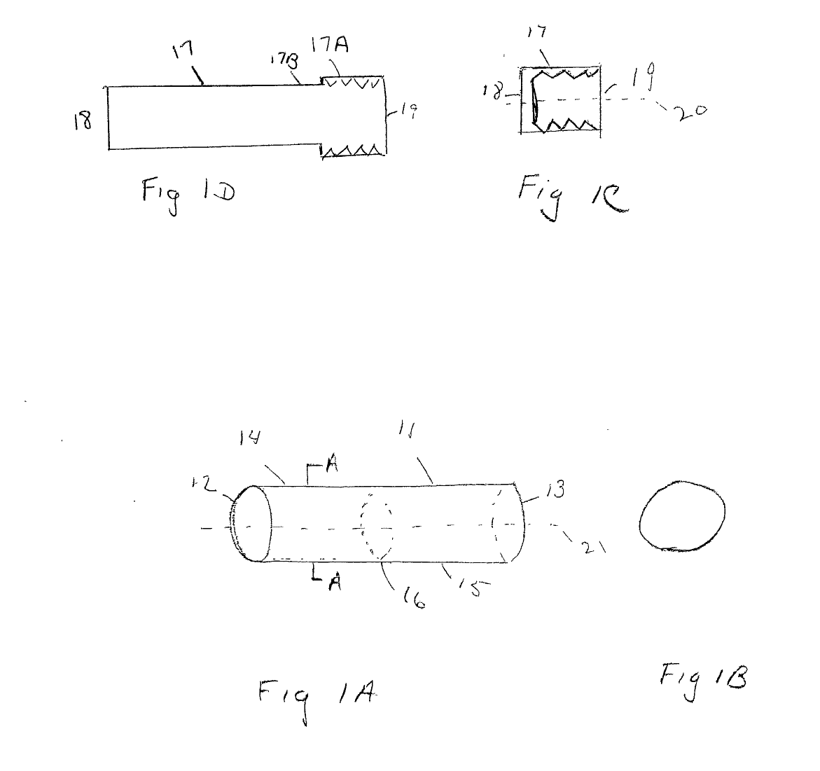

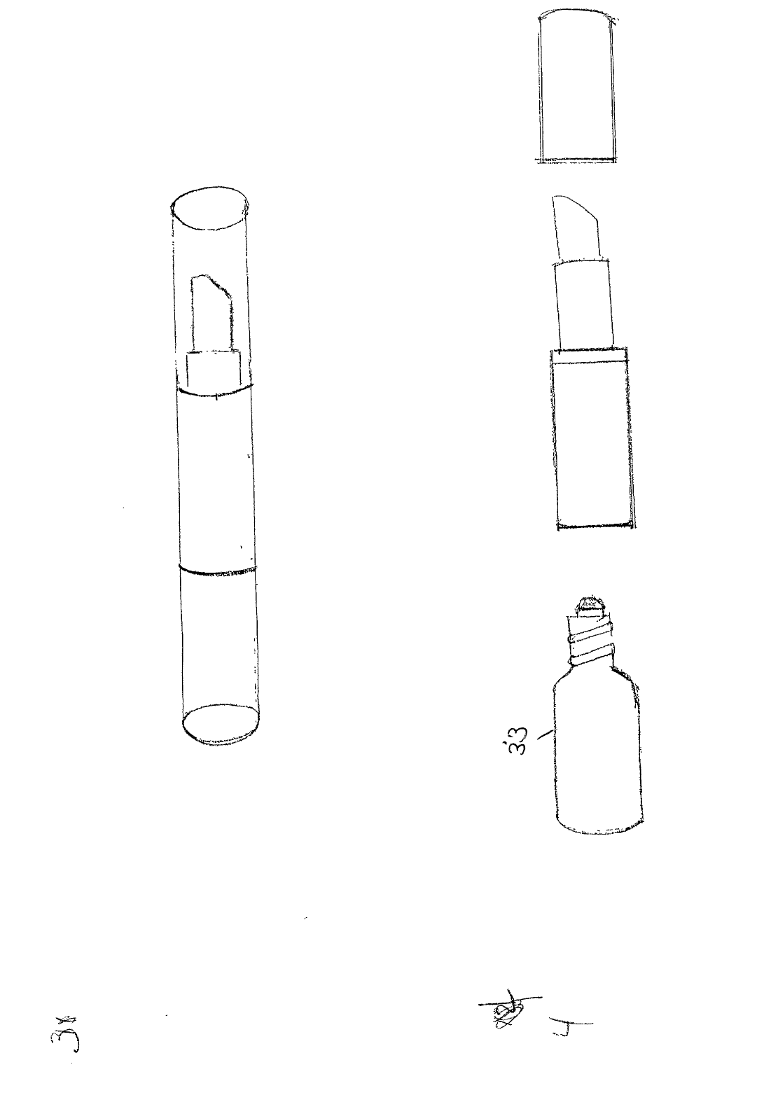

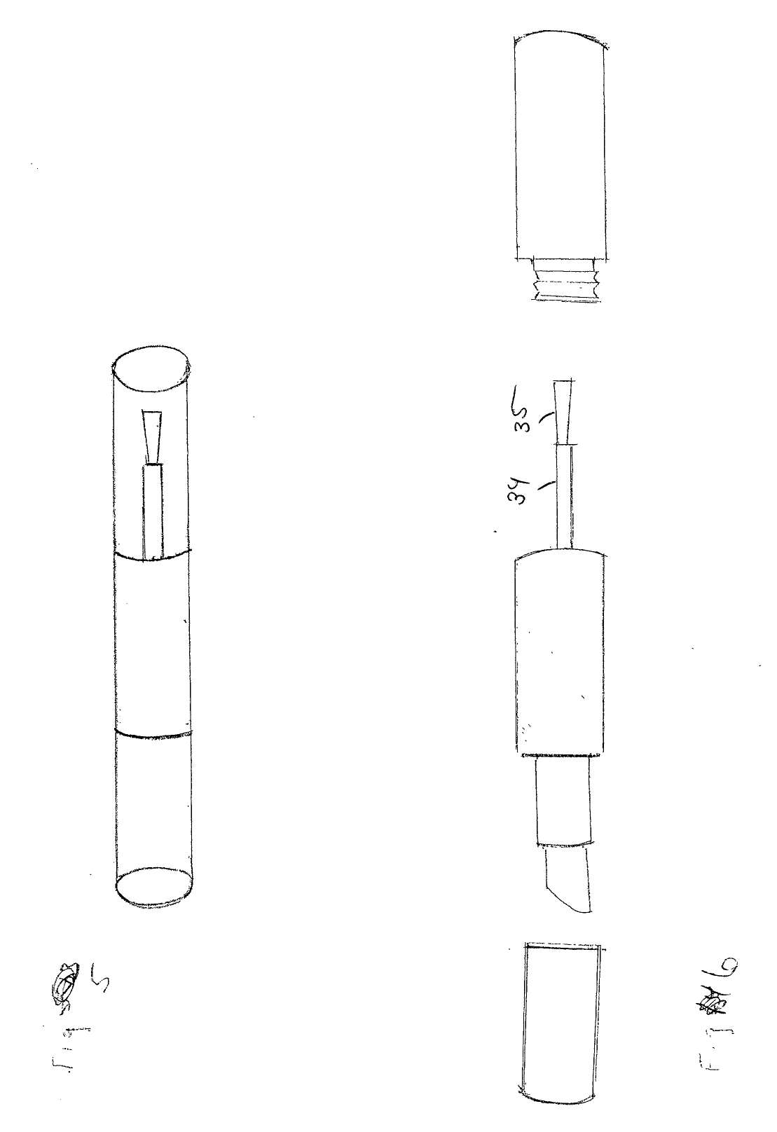

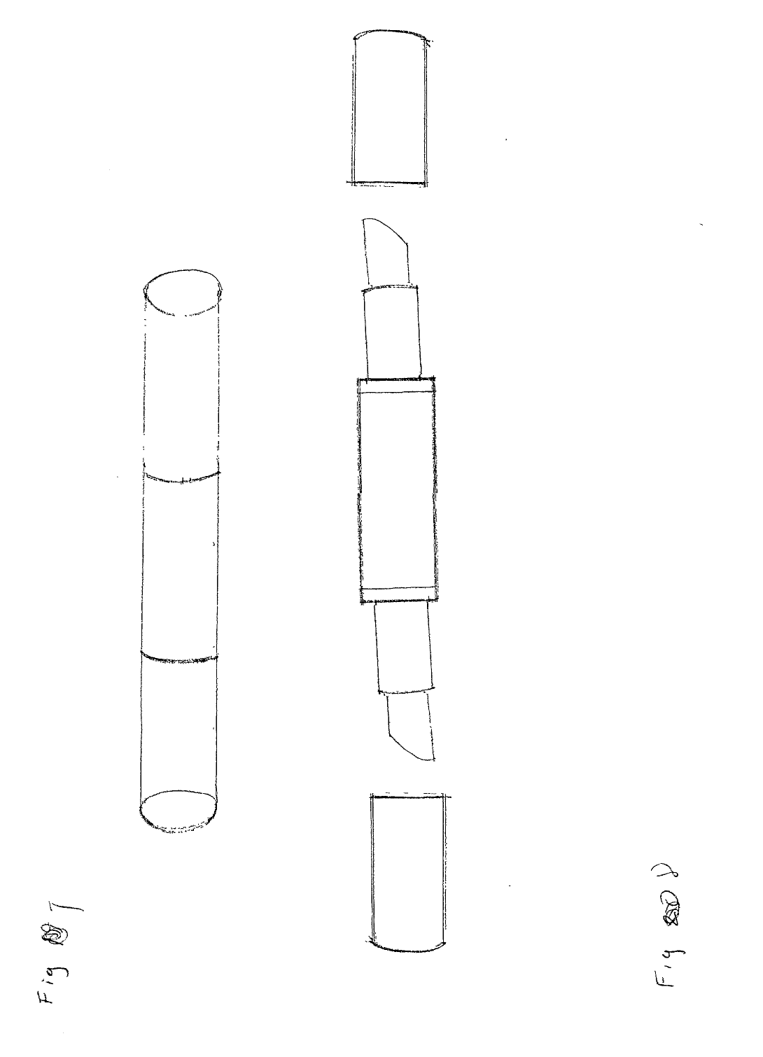

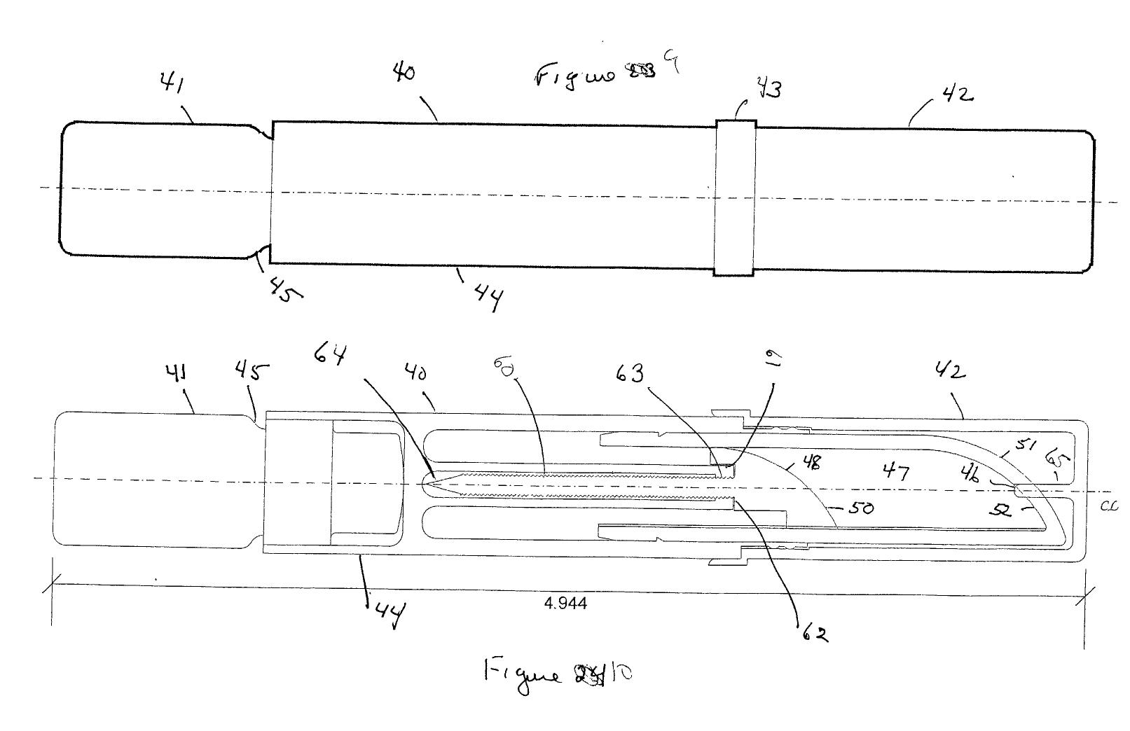

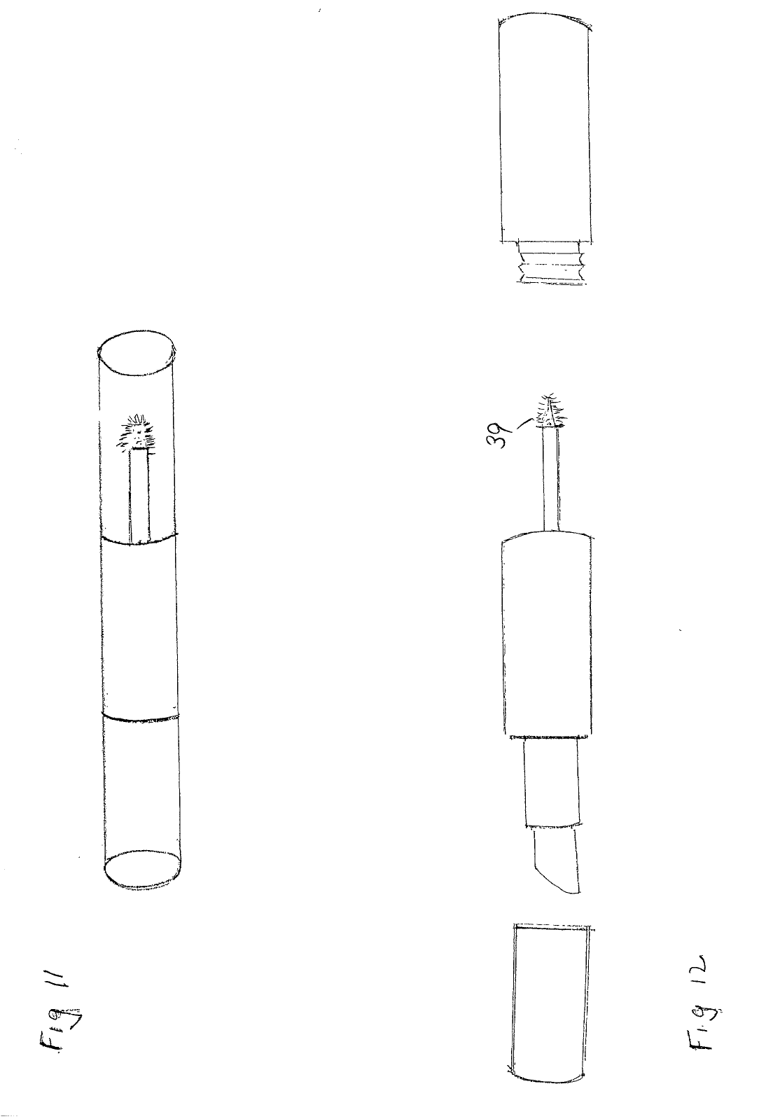

The dual cosmetic container 10 of the present invention has a central body or sleeve 11 (See FIG. 1A) that has a first end 12 and a second end 13 and which may be hollow throughout its entire length or at least have two portions thereof each for receiving and preferably retaining an end of a receptacle containing a products such as one of many different types of cosmetic type products. The sleeve 11 may have a cross-section or any shape, however, the cross-section will typically be round or square, elliptical or ovoid. In one embodiment, the sleeve may have two sections 14 and 15 which are connected by a sidewall 16. The first section 14 and the second section 15 are preferably opened and are preferably threaded on their interior surface so that they are adapted to receive a threaded end of a receptacle which contains a product. Alternatively, the first section 14 and the second section 15 may be adapted to receive and connect with the end of a receptacle that has any other type of connecting means such as a bayonet fitting or a snap fitting for retaining a receptacle in the sleeve. In some instances a friction fit may also be satisfactory. The receptacles may be held in place by any other means known to those skilled in the art.

In one embodiment, the sections 14 may have a conventional threaded cap, see FIG. 1C, inserted into the sleeve with the caps in a head to head relationship. The section 15 is preferably in the form of a conventional lip stick cap although it can be similar to section 14. See FIG. 1C. Alternatively, the cap for section can be as shown in FIG. 1D. In this embodiment the portion of the sleeve in which the section 15 is present may relatively longer than the portion of the sleeve for section 14. The caps have a side wall 17, an end wall or head wall 18 and an open end 19, the interior of which may be threaded. As seen in FIG. 1D only a portion of the interior 17A may be threaded. The side wall 17 may be as shown in FIG. 1D or the entire sidewall may be without a recess portion 17B. When two caps are inserted into the sleeve, the end wall 18 of each are typically in contact with each other or the sidewall 16. The open ends of the sleeve 12 and 13 correspond to the open end of the caps 19. The body or sleeve 11 may be any length but it is preferably only of sufficient length to contain the pair threads or other receiving means for receiving a pair receptacles as well as the center wall, if present, that separates the products contained in each receptacle. The sleeve 11 may be made of any suitable material such as a metal or plastic, preferably a polished of matte metallic finish. Where caps are inserted into the sleeve, the central body 11 may also be any length but is preferably only of sufficient length to accommodate the caps at the first and second ends and the end walls of the caps. Where a pair of threaded caps are placed in a head to head relation in the sleeve preferably, the center axis 20 of each cap is preferably generally lined up with the other cap in a generally straight line. In addition, the center axis 21 of the sleeve and the center axis 20 of each of the caps preferably similarly line up in a generally straight line.. Although depicted with the caps in an end to end relation one skilled in the art will appreciate that the ends need not be in a head to head position but rather, the heads may be off set.

Removably attached to each cap is a receptacle 22 for containing a product. This receptacle may be of any shape. However, in a preferred embodiment the central body is round in its cross section and the receptacles are also round. In a more preferred embodiment the diameter of the receptacles and the diameter of the central body are generally the same. In a most preferred embodiment the cross-section of the receptacles and the cross-section of the central body are generally the same shape.

In one embodiment, one receptacle may be provided on its open end with a roller ball applicator 23 for applying product onto the user. In order to prevent essential oils and/or moisture from unnecessarily escaping from the receptacle the roller ball may have a spring that seats the ball firmly in the rim 24 of the receptacle. The arrangement of the rollerball and spring are described in more detail in our U.S. Pat. No. 5,526,960, the disclosures of which are incorporated herein by reference. The rollerball of the present invention may be colored as described in more detail in our U.S. application Ser. No. 09/515,955 the disclosures of which are incorporated herein by reference.

In one embodiment, as shown in FIG. 1 one of the receptacles 22 is preferably intended for a product containing a fragrance including but not limited to a perfume product. Other products that may be packaged therein include facial products such as powders, creams concealers, blemish control materials, cosmetic serum, etc. In addition. the receptacle 22 may contain a lip product such as a lip stain, a clear lip gloss, a liquid product, etc. The product contained in receptacle 22 may be any product that contains a fragrance and can be a liquid, a semi-liquid or pasty consistency or an solid. The perfume product may be dispensed in any suitable fashion such as by a small orifice in the threaded end of the receptacle. Alternatively, the perfume may be dispensed by means of a spray applicator removably connected to the receptacle. The eye product may be a mascara. an eye liner, etc. In another embodiment the eye product may be dispensed by a rollerball arrangement in a receptacle similar to the receptacle 22 as described above, by an applicator 26 that extends from the cap into the receptacle or other suitable means.

As shown in FIG. 1 the container of the present invention may have a perfume product in one receptacle 22 and an lip product in the other receptacle 28 in a single dual product package. As discussed above the perfume product may be dispensed by any suitable means. The lip product may include a lip stick, a lip gloss, a lip stain, a lip liner etc. The lip product may be in the form of a stick 29. If the lip product is a pasty material, the lip product may be dispensed by means of an applicator of the type shown in FIG. 14, i.e. a soft flexible absorbent material that is on the end of an applicator stick or a brush. In another embodiment a pasty lip product may be dispensed by means of a receptacle having on its end, a flexible material having an orifice in generally the center of the tip. This applicator is preferably used with a receptacle that is flexible and which may be gently squeezed to facilitate the movement of product from the receptacle to the tip where it will be applied to the user. In another embodiment the receptacle may have a base that turns forcing product from the orifice in the manner shown in our copending U.S. patent application Ser. No. 09/515,956 filed Feb. 29, 2000. Similarly, a plunger type arrangement may be present whereby pressure on the plunger forces product to be dispensed from an orifice in the tip of the receptacle. In a preferred embodiment, the applicator tip of the receptacle is made of a soft flexible material such as a soft plastic and given a profile that is angled to give it a shape similar to a traditional stick of lipstick for ease of application.

In addition to the embodiments depicted in FIGS. 1-2 whereby there is a lip product and a perfume product dispensed, as shown in FIGS. 3 and 4 one receptacle 33 may be used for a facial product such as a powder, a cream etc. The facial product may be dispensed by a number of means. In one embodiment, the facial product may be dispensed by means of a receptacle 33 having a rollerball arrangement as described above. In one embodiment, the rollerball arrangement may be provided with a spring as described above. The surface of the roller ball be smooth or slightly roughtened depending on the consistency of the product to be dispensed. Alternatively, the facial product may be dispensed by means of a brush 35 that is attached to the inside surface of the cap and which extends into the receptacle where it contacts a facial material such as blush, powder, cream etc. See FIG. 6.

FIGS. 5 and 6 show a container of the present invention for a lip product and an nail product in a single package. The receptacle 32 may contain a nail product. The nail product may be a nail polish or a hardener that is applied over a nail polish etc. The nail product may be dispensed by means of an applicator that is in the form of a brush 35 or other suitable means. The brush 34 may be attached to the inside of the cap by a shaft 34, generally located toward the center of the inside top surface of the cap in the sleeve. By the term cap is meant a cap as shown in FIG. 1C or the threaded interior of the sleeve where the side wall 16 constitutes the surface for appending the shaft.In an alternative embodiment, the receptacle 33 may contain an eye product. The eye product may be a mascara. an eye liner, etc. In another embodiment the eye product may be dispensed by a rollerball arrangement in a receptacle similar to the receptacle 22 as described above, by an applicator 35 that extends from the cap into the receptacle or other suitable means. In one embodiment the applicator may be a doe foot applicator 26. See FIG. 14.

FIGS. 7 and 8 show a container of the present invention where the receptacles are for a pair of lip products. In one embodiment of FIG. 7, one receptacle may contain a lip gloss enhancing material and the other a lip coloring product.

FIG. 9 depicts an alternate arrangement of the containers of the type shown in FIGS. 1 and 3. In this embodiment there is a dual ended container 40. One end has a receptacle 41 that is preferably for containing a product containing a fragrance such as a perfume. Another product that can be contained in receptacle 41 is a facial product. Receptacle 41 may be provided with a rollerball applicator as shown in FIG. 2. At the end of container 40 opposite receptacle 41 is a cap 42. Cap 42 has a skirt 43 which camouflages any differences in the diameters of sleeve 44 and cap 42 that may occur in the manufacturing process. Receptacle 41 is shown with a tapered neck 45.

FIG. 10 is a cut away view of the container of FIG. 9. The receptacle 41 has a threaded neck (See FIG. 2) the mates with threads in the sleeve. There is a rollerball on the end of the receptacle that is pushed down when the receptacle 41 is threaded into the sleeve. The retraction of the roller ball seals the product in the receptacle. The arrangement of the rollerball and spring in the receptacle 41 are described in more detail in our U.S. Pat. No. 5,526,960. At the end of the container 40 opposite the receptacle 41 may be a lip applicator. One embodiment of the lip applicator is shown in more detail in FIG. 10. The lip applicator 51 has an application surface that is shaped similar to the traditional shape of lip sticks where on side of the applicator surface is provided with a taper. In a preferred embodiment the applicator surface is a soft plastic material. The lip applicator surface is provided with at least one orifice 49 for lip product to exit the interior of the container to be applied by a user. The product 47 is pushed out the orifice by a driving member 48 that is provided with a upper surface 50 that has the same shape as the interior surface 52 of the applicator surface 51. Driving member 48 rises in the interior of the applicator and forces product out through the orifice 49. By having the upper surface of the driving member with the same general shape as the interior surface of the applicator surface more product is evacuated from the applicator that would otherwise be possible. The driving member 48 can be caused to rise in the applicator by any suitable means. In one embodiment the driving member 48 can be driven by a threaded post 60. As threaded post 60 turns the threads interact with the threads 63 on first and second retaining members 61 and 62. Threaded post 60 is provided with a tapered end 64 for ease of insertion between retaining members 61 and 62. As the sleeve 44 is turned the post 60 is driven upwardly forcing product out through the orifice. Cap 42 is preferably provided with a post 65 to seal the orifice. The mechanism shown in FIG. 10 is just representative of the types of mechanisms that may be used.

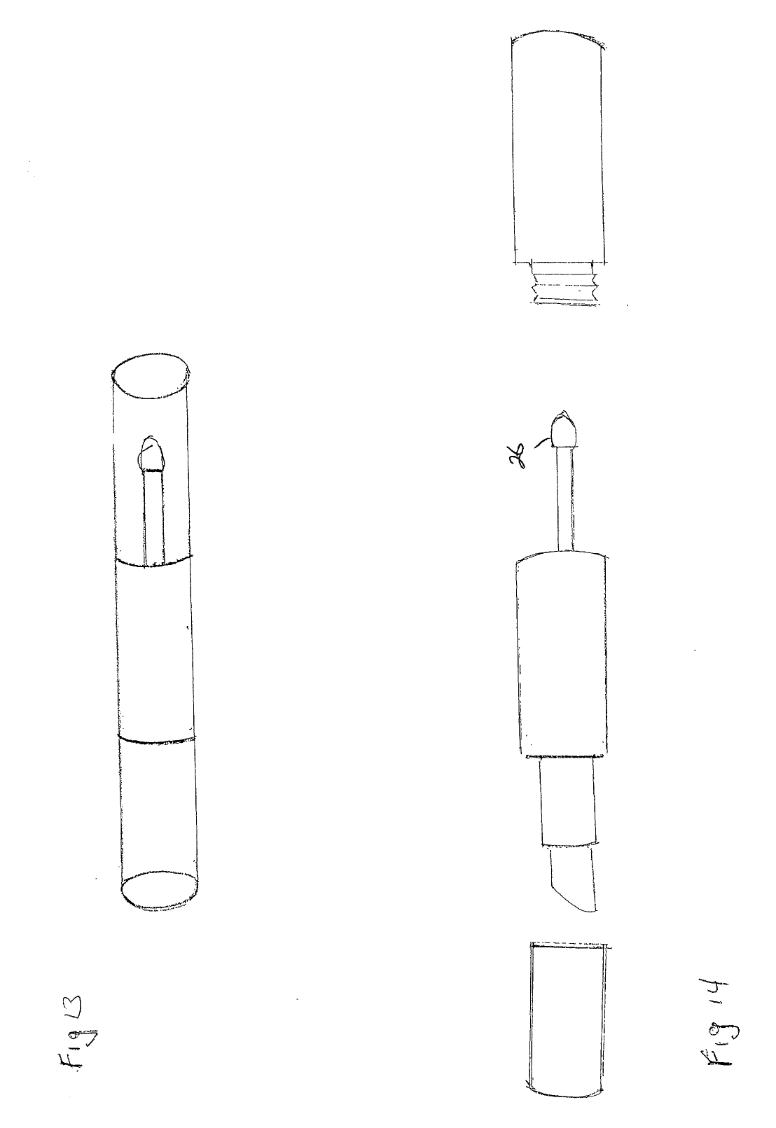

FIG. 11 shows a side view of the container of the present invention for a lip product and a second product in a single package where the second product may be applied by a mascara type brush 39. FIG. 12 shows the container of FIG. 11 with the components separated. FIG. 13 shows a side view of the container of the present invention for a lip product and a second product in a single package where the second product may be applied by a doe foot applicator 26. FIG. 14 shows the container of FIG. 13 with the components separated.

We claim

1. A dual ended container comprising a sleeve that has a first end and a second end, the first of said ends being adapted to receive a receptacle for containing a product and the second end of said sleeve having a lip product applicator extending therefrom, said lip product applicator being adapted to receive a cap to protect the contents of the applicator.

2. The dual ended container of claim 1 wherein the end of the sleeve that is adapted to receive a receptacle is threaded so that it is adapted to receive a threaded end of a receptacle which contains a product.

3. The dual ended container of claim 1 wherein the product contained in the receptacle is a cosmetic product.

4. The dual ended container of claim 3 wherein the sleeve, the cover on the lip applicator and the receptacle have a cross section of the same shape.

5. The dual ended container according to claim 4 wherein the sleeve, the cover on the lip applicator and the receptacle each have a cross section of the same size.

6. The dual ended container according to claim 4 wherein the center axis of the sleeve, the cover on the lip applicator and the receptacle are the same.

7. The dual ended container according to claim 6 wherein the portion of the cover of the lip applicator where there is a thread on the interior thereof forming a band around said cover.

8. The dual ended container according to claim 1 wherein the product in the second receptacle contains a product containing a fragrance.

9. The dual ended container according to claim 8 wherein the product containing a fragrance is a perfume.

10. The dual ended container according to claim 8 wherein the receptacle has a rollerball applicator for applying the product containing a fragrance.

11. The dual ended container according to claim 1 wherein the product in the second receptacle is an eye product.

12. The dual ended container according to claim 11 wherein the eye product is an eye liner.

13. The dual ended container according to claim 11 wherein the second receptacle has a doe foot applicator for applying the eye product.

14. The dual ended container according to claim 11 wherein the second receptacle has a rollerball applicator for applying the eye product.

15. The dual ended container according to claim 11 wherein the second receptacle has a brush for applying the eye product.

13. The dual ended container according to claim 11 wherein the eye product is a mascara.

14. The dual ended container according to claim 13 wherein the second receptacle has a mascara brush for applying the mascara.

15. The dual ended container according to claim 1 wherein the product in the second receptacle is a facial product.

16. The dual ended container according to claim 15 wherein the product in the second receptacle is a powder.

17. The dual ended container according to claim 15 wherein the product in the second receptacle is a cream.

18. The dual ended container according to claim 15 wherein the product in the second receptacle is a concealer.

19. The dual ended container according to claim 15 wherein the product in the second receptacle is a blemish control material.

20. The dual ended container according to claim 15 wherein the second receptacle has a rollerball applicator for applying the facial product contained therein.

21. The dual ended container according to claim 15 wherein the second receptacle has a doe foot applicator for applying the facial product contained therein.

22. The dual ended container according to claim 15 wherein the second receptacle has a brush for applying the facial product contained therein.

23. The dual ended container according to claim 1 wherein the product in the second receptacle is an nail product.

24. The dual ended container according to claim 23 wherein the nail product in the second receptacle is an nail polish.

25. The dual ended container according to claim 23 wherein the nail product in the second receptacle is an nail hardener.

26. The dual ended container according to claim 23 wherein the second receptacle has a brush for applying the nail product container therein.

27. The dual ended container according to claim 1 wherein the product in the second receptacle is a cosmetic serum.

28. The dual ended container according to claim 1 wherein both of the receptacles contain lip products.

29. A dual ended container comprising a sleeve that has a first end and a second end, each of said ends being adapted to receive a receptacle for containing a product and wherein the product in the first receptacle is different from the product in the second receptacle and wherein the product contained in at least one said receptacle is a lip product.

30. The dual ended container of claim 29 wherein the sleeve has a first section and a second section which are connected by a sidewall, said first section and the second section being opened at each of said ends and threaded so that they are adapted to receive a threaded end of a receptacle which contains a product.
